(19) United States
(12) Patent Application Publication
(10) Pub. No.: US 2014/0024459 A1
(43) Pub. Date: Jan. 23, 2014

(54) PROVIDING A REAL-TIME MULTIPLAYER GAMING PLATFORM OVER A WIDE AREA NETWORK USING CLOCK-BASED TIMING METHODOLOGY

(71) Applicant: Social Graph Studios Inc., Maple (CA)

(72) Inventors: Oz SOLOMON, Maple (CA); Dan Parish, Seattle, WA (US)

(21) Appl. No.: 13/944,888

(22) Filed: Jul. 18, 2013

Related U.S. Application Data
(60) Provisional application No. 61/674,671, filed on Jul. 23, 2012.

(51) Int. Cl. A63F 13/12

(52) U.S. Cl. CPC A63F 13/12
USPC 463/42

(57) ABSTRACT

A method of providing a real-time multiplayer gaming platform over a wide area network using clock-based timing methodology is provided herein. The method includes the following steps: receiving over a network, from a plurality of client computers, a plurality of respective proposed actions in a multiplayer computer game; associating each one of the proposed actions with a timestamp over a common timeline; applying a synchronization and conflict resolution function to the plurality of time stamped proposed actions, based on predefined rules of the multiplayer computer game and priority of time stamped proposed actions over the timeline, to yield a set of synchronization cues, action approvals and action rejections associated with the proposed actions; sending the approvals and/or rejections to the client computers, respectively; and generating, at each one of the client computers, an animation that corresponds with the sent synchronization cues, action approvals, or actions rejections, where applicable.

### CROSS-REFERENCE TO RELATED APPLICATIONS

This application is a non-provisional application of U.S. Provisional Patent Application No. 61/674,671, filed on Jul. 23, 2012, which is incorporated herein by reference in its entirety.

### FIELD OF THE INVENTION

The present invention relates to a computerized multiplayer gaming platform implemented over a wide area network and more particularly, to a conflict and synchronization resolving mechanism implemented on such platforms.

### BACKGROUND OF THE INVENTION

Multiplayer gaming platforms implemented over wide area networks pose a true challenge for computer game developers specifically in action-intense games. The challenge arises whenever two or more players, either humans or bots (hereinafter: users), each operating at a different client computer, perform actions that are each propagated to a common server over different time periods, where those actions can be either independent, interdependent, or conflicting. The server, upon receiving these actions needs to synchronize them, notify the users of any existing (possibly modified) actions, and possibly reject at least one of the conflicting actions.

One solution known in the art for the aforementioned challenge is to perform, at the client side, a simulation of the proposed action before sending it (or concurrently therewith) to the server for validation. The simulation at the client side is carried out based on predefined heuristics which adhere to the rules of the specific game, knowing all possible actions and combination thereof. These solutions necessitate keeping a synchronization and conflict resolution mechanism at the client side and further providing game-specific rules for synchronization and conflict resolution of each and every game.

It would, therefore, be advantageous to provide a synchronization and conflict resolution mechanism that is generic so as to suit a large variety of computer games.

### BRIEF SUMMARY OF THE INVENTION

One embodiment of the invention provides a method of providing real-time multiplayer gaming platform over wide area network using clock-based timing methodology is described herein. The method includes the following stages: receiving over a network, from plurality of client computers, a plurality of respective proposed actions in a multiplayer computer game; associating each one of the proposed actions with a timestamp over a common timeline; applying a synchronization and conflict resolution function to the plurality of time stamped proposed actions, based on predefined rules of the multiplayer computer game and priority of time stamped proposed actions over the timeline, to yield a set of approvals, modifications, and rejections associated with the proposed actions; sending the approvals and the rejections to the client computers; and executing the received approval or rejection at the client computers and auto synchronizing, where applicable.

Other embodiments of the invention may include a system arranged to execute the aforementioned method and a computer readable program configured to execute the aforementioned method. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating the system according to some embodiments of the invention;

FIG. 2 is a high level flowchart illustrating an aspect according to some embodiments of the invention;

FIG. 3 shows a sample of a possible game board in a multiplayer match-3 game; and

FIG. 4 shows a timeline diagram illustrating an aspect according to some embodiments of the invention;

The drawings together with the following detailed description make apparent to those skilled in the art how the invention may be embodied in practice.

### DETAILED DESCRIPTION OF THE INVENTION

Prior to setting forth the detailed description, it may be helpful to set forth definitions of certain terms that will be used hereinafter.

The term “conflict” as used herein refers to an event whenever at least two users on a multiplayer gaming platform take actions that are not possible to execute simultaneously in accordance with the rules of the computer game. This can be caused by moving the same piece at the same time but to different locations for instance, or taking actions on an out-of-date board.

The term “tick” as used herein refers to a predefined and constant period of time of sequential logic (clock driven logic). A tick is usually defined as the time lapsing between two rises of the clock in a sequential logic system. For example, a tick in a real-time computer game may be 250 ms.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments or is capable of being practiced or carried out in various ways. Also, it is to be understood that the phraseology and terminology employed herein is for the purpose of description and should not be regarded as limiting.

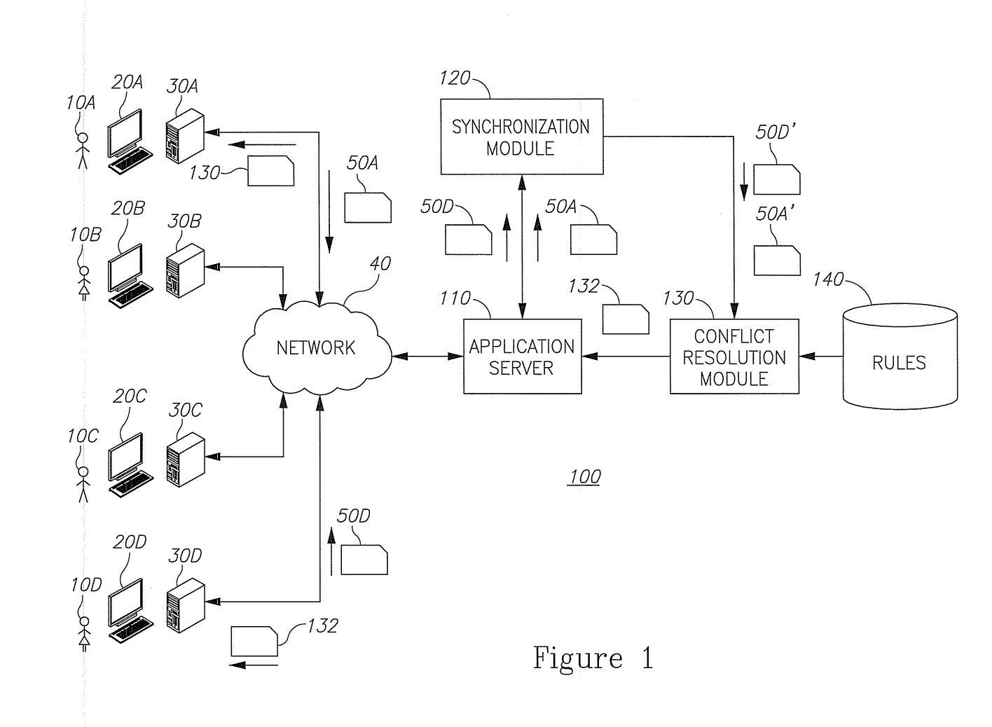

FIG. 1 is a high level schematic block diagram illustrating an environment of a system 100 according to some embodiments of the invention. The environment is a wide area network 40 to which a plurality of client computers 30A-30D are connected. Each one of the client computers 30A-30D may be associated with a human or non-human player 10A-10D that may be playing a multiplayer computer game over a respective display 20A-20D with any of the other human or non-human players.

System 100 is configured to provide real-time multiplayer gaming platform over wide area network 40 using clock-based timing methodology. System 100 includes an application server 110 configured to receive over network 40, from plurality of client computers 30A-30D, each associated with a player 10A-10D, a plurality of respective proposed actions (e.g., 50A and 50D) in a multiplayer computer game.

System 100 includes a synchronization module 120 configured to associate each one of the proposed actions (e.g., 50A and 50D) with a timestamp (e.g., 50A′ and 50D′) over a common timeline. Synchronization module 120 is configured to update the timestamps, if needed, at the end of each clock (or ‘tick’) so as to remedy any lagging due to delays over network 40.

System 100 further includes a synchronization and conflict resolution module 130 configured to apply a conflict resolution function to the plurality of time stamped proposed actions (e.g., 50A′ and 50D′), based on predefined rules 140 of the multiplayer computer game and priority of time stamped proposed actions over the timeline, to yield a set of approvals and rejections 132 associated with the proposed actions. Additionally, each one of client computers 30A-30D may further include an animation module (not shown) configured to generate a rejection, approval, or synchronization animation for each one of the rejections, approvals, or synchronization actions sent by the server. Specifically, a rejection animation is so selected that it masks the reversing of the proposed action.

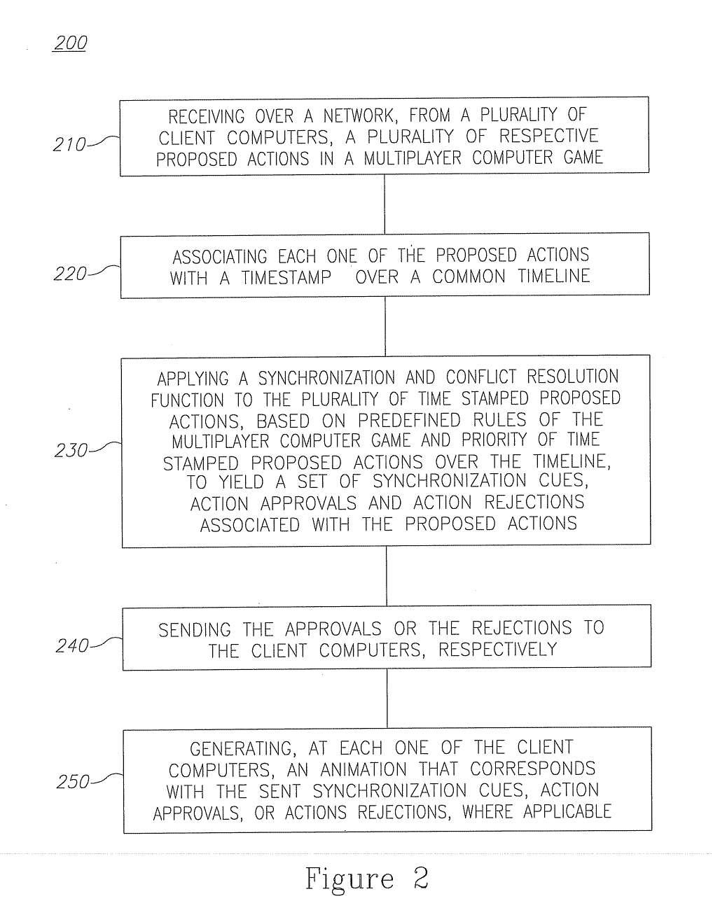

FIG. 2 is a high level flowchart illustrating an aspect according to some embodiments of the invention. Method 200 implements the present invention in a manner not necessarily identical to the implementation shown in the aforementioned architecture of system 100. Method 200 includes the following stages: receiving over a network, from plurality of client computers, a plurality of respective proposed actions in a multiplayer computer game 210; associating each one of the proposed actions with a timestamp over a common timeline 220; applying a synchronization and conflict resolution function to the plurality of time stamped proposed actions, based on predefined rules of the multiplayer computer game and priority of time stamped proposed actions over the timeline, to yield a set of approvals and rejections associated with the proposed actions 230; sending the approvals and rejections to the client computers 240; executing at the client computers the received approvals, the received rejections, and the synchronization actions, respectively 250.

Advantageously, when implementing the embodiments of the present invention, users should feel like they are playing a fast-paced real-time game. To minimize the number of times a player's action gets rejected, wherever possible, conflicts or potential problems should not interfere with the user's game. Where conflicts or problems are unavoidable, users can understand what is happening and are satisfied with the outcome.

Embodiments of the present invention should not be limited to solving the conflicts outlined herein. It should be understood that many other potential conflicts not shown here may be solved in a similar manner that benefit the clock based conflict resolving methodology outlined herein. Additionally, those who are skilled in the art would be able to implement ad hoc conflict mitigation rules that utilize the clock-based conflict check methodology in many multiplayer gaming platforms that are implemented over wide area networks.

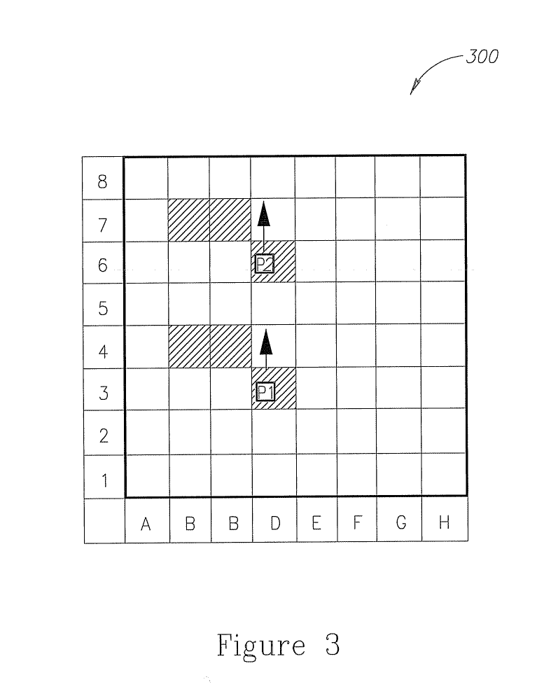

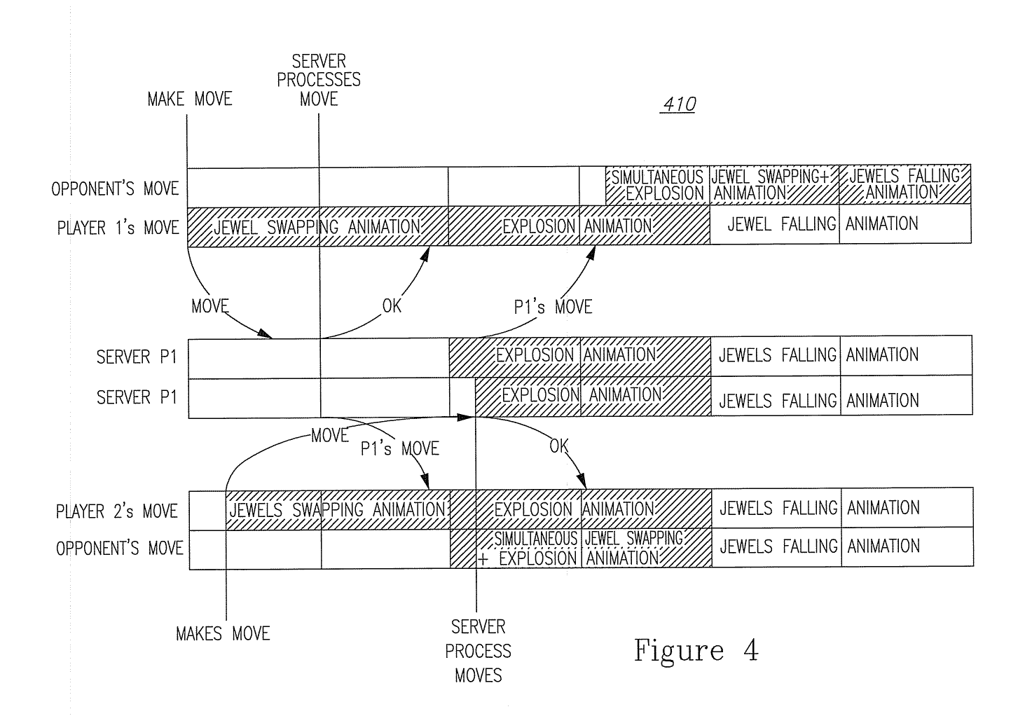

By way of example, embodiments of the conflict resolving methodology will be demonstrated below using a multiplayer match-3 jewel game, Jewels x2. FIG. 3 comprises a high level schematic block diagram 300 depicting the game and a timeline diagram 410 illustrating an aspect according to some embodiments of the invention is shown in FIG. 4. It should be understood that the use of Jewels x2 is merely for illustrative purposes and should not be regarded as limiting. The following are decisions that may be taken considering the mechanics of taking actions in Jewels x2 and their justifications. For practical purposes, once a player initiates an action, the board is locked for that player until the complete action sequence (move, explosion, new jewels falling—all of which are associated with respective animations), including any chain reactions the move causes, is completed. This is a common behavior at other jewel-type games. It also matches a player's expectations as people generally don't try to make actions until their previous action is complete. Locking the board provides the platform with the necessary time to complete the network transactions and also reduces the number of possible conflicts. A player's board is mostly unlocked when displaying an opponent's action.

Prior to starting the game, the two clients and the server establish a synchronized base time between them. This common base time allows synchronizing actions between all three.

Timelines are the fundamental structures that define an action. A timeline is comprised of many ticks. By way of example, each tick may be 250 ms in length. When a player initiates an action, that action is sent to the server with the timestamp the action was initiated at. If the server receives an action and is not currently executing another action, the server will start a new timeline retroactively at the time that the action originally commenced at.

This concept is demonstrated in the example below. If a player initiates an action at t₀ and it arrives at the server at t₀+50, the server will understand that the action started at t₀, and so the server starts the timeline there, not at t₀+50.

Before sending a response to the player that initiated the timeline, the server will wait until the end of the first tick to see if any actions from the opposing player also arrive. If an action from the opposing player arrives within that same tick, the actions will be said to have occurred simultaneously. This will increase fairness so that the player with the lower latency doesn't always win a conflict.

Following is an example that demonstrates this concept: If Player 1 initiates an action at t₀ and it arrives at the server at t₀+50, and the server does not currently have a timeline executing, then the server still will not process the action until t₀+250=t₁ being the end of the first tick. If Player 2 also makes an action after t₀ and it arrives before t₁, then the actions will be said to have occurred simultaneously.

If the later action to arrive at the server (that arrives within the same tick) has been delayed and actually started before the server's current t₀, the server could instead set its t₀ to equal the later action's origination time (that actually occurred earlier). This may mean that the end of the tick has already passed, and if so, responses will be sent to both players immediately.

Example: Player 1 initiates an action at RealTime₀, but it is delayed. Player 2 initiates an action at RealTime₀+100 and it arrives at the server at RealTime₀+150. The server then starts its timeline at t₀=(RealTime₀+100) and waits for 200 ms for a move from the opposing player.

At to +125 (so RealTime₀+225) the server receives Player 1's move. Since Player 1's move actually started earlier, the server could reset its timeline to start at t₀=RealTime₀ and immediately send a response to both Player 1 and Player 2.

When there are no moves executing on the server there is essentially no timeline. The next timeline starts the next time the server receives a move.

It should be noted that ticks (as opposed to just arbitrary lengths of time) are used to specify the length of the individual portions of a move to easily allow the server to keep the clients synchronized.

Following is an explanation of how actions are processed in accordance with some embodiments of the present invention. The times allocated for each stage of an action you take are as follows. Each action (and there is a closed list of actions) is associated with a specific interval which is measured in a number of ticks. Some of the actions are dependent upon further parameters, as they may be dependent upon a specified variable distance within the game environment.

The times allocated for each action include a built-in “delay” in order to pad the animations out to encompass entire ticks. The delays will be short enough that they won't be noticed, but will also provide flexibility when needed to shorten animations because of delayed actions, etc.

If a player 1 takes an action and the opposing player 2 already has an action executing on the server, player 1's timeline will need to be synchronized with the opposing player's. This may require shortening the move's delay or animation, or removing the delays entirely.

Referring now to timeline 410, an example scenario where Player 2's action (a move) arrives late is illustrated. The diagram shows how the server and the clients deal with this challenge. Specifically, the server is able to merge Player 2's move into the timeline started by Player 1. The server starts Player 2's move retroactively, which means the server needs to internally shorten the length of the explosion stage. Since, when the server receives Player 2's move, it is already executing Player 1's action (also a move), it is able to respond immediately without waiting until the end of the tick. Player 1's client receives Player 2's move late, and so needs to be able to shorten its subsequent animations to make it fit into its already executing timeline. Player 2's client receives Player 1's move prior to the server's response for its own move, at which point it synchronizes to Player 1's timeline automatically. Because Player 2's client now has the information for Player 1's move, it can predict that the server will approve its own move (in this case) and therefore can start executing the explosion for its own move even before receiving the server's response

According to another aspect of the invention, because of the inherent latency and processing times involved in taking an action, a user will not see its opponent's action for about two ticks after it was taken. Given that, for opposing users' actions, an animation that is shorter than usual will be used in order to allow the game client's visualizations to “catch up” with the shared timeline. The game needs to be designed in such a way that relevant animations are long enough so they can be shortened when showing opponent moves.

According to another aspect of the invention, when displaying an opponent's action (especially if it is delayed), it is possible that the game elements involved in that action may not be in the same state anymore because of an action that the current user made. This means that a user may see visualizations of the action that don't always appear to correspond to the object's state prior to the visualization.

While it is attempted to allow actions to complete as often as possible, there will still be cases where two or more actions are in conflict and one or more need to be rejected. For instance, if two users move the same game elements to different locations at the same time, only one move can be allowed to be completed. In cases where there is a conflict, the conflict may be resolved by round-robin in order to be as fair as possible. This will allow each player to win every other conflict.

Usually, rejection animations last at least one, and no more than two, ticks. They are started as soon as a client knows about a conflict, and animated for between one and two ticks, always ending at the end of a tick.

Example: Player 2 makes a move at t₀, but at t₁+50 receives a notification that the move was rejected. Player 2's client will then animate the rejection animation starting at t₁+50, but it won't end until t₃, which is 450 ms away.

Ensuring that a rejection animation always ends at the end of a tick will allow for easier synchronization with other game board events, and doesn't negatively impact the player in any meaningful way.

The server will make the decision as to whether one action is in conflict with another by comparing each action with its current game state when it receives that action. This means that an action that is valid at the time it is taken could still be rejected if it is delayed arriving at the server.

It should be noted that the client can also make a decision as to whether its own action is in conflict (and will, therefore, be rejected) if it has already received an approval for an opponent's action that is judged to be in conflict.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

The principles and uses of the teachings of the present invention may be better understood with reference to the accompanying description, figures and examples.

It is to be understood that the details set forth herein do not construe a limitation to an application of the invention.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of providing a real-time multiplayer gaming platform over a wide area network using clock-based timing methodology, the method comprising:
receiving over a network, from a plurality of client computers, a plurality of respective proposed actions in a multiplayer computer game;
associating each one of the proposed actions with a timestamp over a common timeline;
applying a synchronization and conflict resolution function to the plurality of time stamped proposed actions, based on predefined rules of the multiplayer computer game and priority of time stamped proposed actions over the timeline, to yield a set of synchronization cues, action approvals and action rejections associated with the proposed actions;
sending the approvals and/or rejections to the client computers, respectively; and
generating, at each one of the client computers, an animation that corresponds with the sent synchronization cues, action approvals, or action rejections, where applicable.

2. The method according to claim 1, wherein the associating is carried out repeatedly at an end of a clock tick.

3. The method according to claim 1, wherein the associating includes merging actions into existing timelines based on time stamps from all client computers by aligning the time stamps on a common timeline.

4. The method according to claim 1, wherein the synchronization and conflict resolution function takes into account delays over the wide area network.

5. The method according to claim 4, wherein the synchronization and conflict resolution function comprises a cost function and is further configured to increase fairness so that actions taken by a user associated with a client computer having a slow or unstable connection over the wide area network are not punished unfairly.

6. The method according to claim 1, wherein the rejection provides visual masking for reversing the proposed action, in a case that the proposed action was already executed on the client computer.

7. A system for providing a real-time multiplayer gaming platform over wide area network using clock-based timing methodology, the system comprising:
an application server configured to receive over a network, from plurality of client computers, a plurality of respective proposed actions in a multiplayer computer game;
a synchronization module configured to associate each one of the proposed actions with a timestamp over a common timeline; and
a synchronization and conflict resolution module configured to synchronize actions into an existing timeline, and apply a synchronization and conflict resolution function to the plurality of time stamped proposed actions, based on predefined rules of the multiplayer computer game and priority of time stamped proposed actions over the timeline, to yield a set of approvals and rejections associated with the proposed actions,
wherein the application server is further configured to send the approvals and rejections to the client computers, respectively, and
wherein the client computers are configured to execute the received rejections, approvals, and synchronization cues, where applicable.

8. The system according to claim 7, wherein the associating is carried out repeatedly at an end of a clock tick.

9. The system according to claim 7, wherein the associating is carried out at the earlier of (a) the end of a tick or (b) the instance where all necessary information to make a perfect determination of outcome is available.

10. The system according to claim 7, wherein the associating includes merging actions into existing timelines based on time stamps from all client computers by aligning the time stamps on a common time line.

11. The system according to claim 7, wherein the synchronization and conflict resolution function takes into account delays over the wide area network.

12. The system according to claim 11, wherein the synchronization and conflict resolution function comprises a cost function and is further configured to increase fairness so that proposes actions made by a player associated with a client computer having a slow connection over the wide area network is not undermined.

13. A computer program product for providing a real-time multiplayer gaming platform over wide area network using clock-based timing methodology, the computer program product comprising:
a computer non-transitory readable medium having computer readable program embodied therewith, the computer readable program comprising:
computer readable program configured to configured to receive over a network, from plurality of client computers, a plurality of respective proposed actions in a multiplayer computer game;
computer readable program configured to associate each one of the proposed actions with a timestamp over a common timeline; and
computer readable program configured to synchronize actions into an existing timeline, and apply a synchronization and conflict resolution function to the plurality of time stamped proposed actions, based on predefined rules of the multiplayer computer game and priority of time stamped proposed actions over the timeline, to yield a set of approvals and rejections associated with the proposed actions;
computer readable program configured to send the approvals and rejections to the client computers, respectively; and
computer readable program configured to execute the received rejections, approvals, and synchronization cues, where applicable.

14. The computer program product according to claim 13, wherein the associating is carried out repeatedly at an end of a clock tick.

15. The computer program product according to claim 13, wherein the associating is carried out at the earlier of (a) the end of a tick or (b) the instance where all necessary information to make a perfect determination of outcome is available.

16. The computer program product according to claim 13, wherein the associating includes merging actions into existing timelines based on time stamps from all client computers by aligning the time stamps on a common time line.

17. The computer program product according to claim 13, wherein the synchronization and conflict resolution function takes into account delays over the wide area network.

18. The computer program product according to claim 17, wherein the conflict resolution function comprises a cost function and is further configured to increase fairness so that proposes actions made by a player associated with a client computer having a slow connection over the wide area network is not undermined.
